(19) United States
(12) Patent Application Publication
(10) Pub. No.: US 2014/0203537 A1
(43) Pub. Date: Jul. 24, 2014

(54) MOVEMENT ASSISTIVE DEVICE AND WHEELCHAIR EQUIPPED WITH SAME

(71) Applicant: Amy Chih-Wei Chiu, Fountain Valley, CA (US)

(72) Inventor: Amy Chih-Wei Chiu, Fountain Valley, CA (US)

(21) Appl. No.: 14/155,584

(22) Filed: Jan. 15, 2014

(30) Foreign Application Priority Data
Jan. 18, 2013 (TW) 102201121

(51) Int. Cl. A61G 5/10

(52) U.S. Cl. CPC A61G 5/104
USPC 280/304; 254/98

(57) ABSTRACT

A movement assistive device includes a vertical lift module and a horizontal extension module. The vertical lift module has a lift table vertically movable upward and downward. The horizontal extension module is arranged atop the lift table to move upward and downward along with the lift table and can be driven to switch horizontally between a first state and a second state. A wheelchair equipped with the movement assistive device is also disclosed. With the movement assistive device, the wheelchair can be vertically lifted and lowered as well as be horizontally displaced, and can therefore be conveniently moved from a ground surface onto a carrier and vice versa.

This application claims the priority benefit of Taiwan patent application number 102201121 filed on Jan. 18, 2013.

### FIELD OF THE INVENTION

The present invention relates to a movement assistive device, and more particularly, to a movement assistive device that enables convenient movement of a wheelchair onto and off a carrier. The present invention also relates to a wheelchair equipped with the movement assistive device.

### BACKGROUND OF THE INVENTION

A wheelchair is an assistive device for helping people with disabilities to move to different places. The wheelchair can be operated by a user or by an operator to move. For wheelchair users to conveniently access different places, some public places are designed to be barrier-free.

There are times the wheelchair user along with the wheelchair needs to get on a vehicle. It would be very difficult and inconvenient for the wheelchair user or the wheelchair operator to perform this action unless the vehicle is equipped with some special movement assistive devices, such as those displayed in the following web pages: http://www.youtube.com/watch?v=5dZpzuDTCso and http://www.youtube.com/watch?v=oFXTN6G4Mmg. However, vehicles and/or wheelchairs equipped with the special movement assistive devices shown in the above web pages have complicate structures and are time and labor consuming in operation to still possibly cause inconvenience and discomfort to the wheelchair users and operators. Moreover, it is very expensive to install the wheelchair-specific lift device on a vehicle, and not all the vehicles are adaptable for installing the wheelchair-specific lift device. Therefore, the problem of transporting a wheelchair and the user sitting thereon has not been thoroughly solved.

There are many prior art patents related to lifting mechanisms for the movement of a wheelchair, some examples are listed below:
(1) U.S. Pat. No. 3,123,400 discloses a wheelchair that can be raised or lowered;
(2) U.S. Pat. No. 3,373,879 discloses an elevating and tilting frame structure;
(3) U.S. Pat. No. 4,771,839 discloses a stair-climbing wheelchair carrier, which includes a carrier portion comprising a pair of endless belt crawlers, and a handle portion rotatably and detachably provided on the carrier; the handle portion is adapted to be rotated between an operating position and a wheelchair engaging position; the endless belt crawler has an oblique overhand portion which has a height higher than a usual height of a step of stair; and a guide body is provided to mount a wheelchair secured to the handle portion so as to be rotated together with the handle portion to the operating position;
(4) U.S. Pat. No. 4,790,716 discloses a device for handling a wheelchair; the device can selectively lift and tilt the wheelchair and its occupant to a convenient position for performance of service to the occupant of the wheelchair; and
(5) US Patent Publication No. US20020149168 discloses an elevating manual wheelchair, which incorporates an elevating mechanism of the scissor type to elevate the wheelchair user to a height greater than that of an able bodied person standing, so that the wheelchair user can do his or her day-to-day living and other activities.

### SUMMARY OF THE INVENTION

A primary object of the present invention is to provide a novel movement assistive device for use with a wheelchair, so that the wheelchair can be more conveniently operated to move vertically and horizontally.

Another object of the present invention is to provide a wheelchair equipped with a movement assistive device, so that a wheelchair user or operator can conveniently move the wheelchair onto and off a carrier.

A further object of the present invention is to provide a movement assistive device that can be used with different apparatuses to easily move the apparatuses vertically and horizontally.

To achieve the above and other objects, the movement assistive device according to a preferred embodiment of the present invention includes a vertical lift module and a horizontal extension module. The vertical lift module includes a lift table vertically movable upward and downward. The horizontal extension module is arranged atop the lift table to vertically move upward and downward along with the lift table, and can be driven to switch horizontally between a first state and a second state.

To achieve the above and other objects, the wheelchair according to the present invention includes a wheelchair main body and a movement assistive device mounted to the wheelchair main body. The movement assistive device includes a vertical lift module and a horizontal extension module. The vertical lift module includes a lift table vertically movable upward and downward. The horizontal extension module is arranged atop the lift table to vertically move upward and downward along with the lift table, and can be driven to switch horizontally between a first state and a second state.

According to an operable embodiment of the present invention, the vertical lift module further includes a base located below the lift table and including a plurality of legs; a first locating sleeve and a second locating sleeve; a reduction unit provided on the base and including an upright rotational screw rod; a lift power unit connected to the reduction unit; a first fixing bar and a second fixing bar vertically downwardly inserted into the first locating sleeve and the second locating sleeve, respectively, so as to locate at two lateral outer sides of the rotational screw rod and be parallel to the rotational screw rod; and a lift support unit including a flange portion, a sleeve portion upward projected from a center of the flange portion, and a bore axially extended through the sleeve portion and the flange portion. The lift support unit is externally fitted around the rotational screw rod to move upward and downward on along the rotational screw rod.

According to an operable embodiment of the present invention, the lift table further includes a central hole, which extends through the lift table in a thickness direction thereof and is externally fitted around the sleeve portion of the lift support unit, enabling the lift table to be supported on the flange portion of the lift support unit; and a first and a second supporting arm, which are separately located at two lateral sides of the lift table. The first supporting arm has a first locating hole provided thereon for movably fitting around the first fixing bar; and the second supporting arm has a second locating hole provided thereon for movably fitting around the second fixing bar.

According to an operable embodiment of the present invention, the rotational screw rod is externally threaded to provide an external thread section, and the bore of the lift support unit is internally threaded to provide an internal thread section for meshing with the external thread section of the rotational screw rod.

According to an operable embodiment of the present invention, the horizontal extension module includes a first slide unit and a second slide unit, which are arranged atop the lift table, and are spaced from and parallel to each other; and a horizontal displacement unit, which is located between and connected to the first and the second slide unit to move horizontally. When the horizontal extension module is in the first state, the horizontal displacement unit brings the first and the second slide unit to move from a first position to a second position. And, when the horizontal extension module is in the second state, the horizontal displacement unit brings the first and the second slide unit to move from the second position back to the first position.

According to an operable embodiment of the present invention, the first slide unit includes a first case and a first slide. The first case is provided at an end with a first connection sleeve for movably fitting around the first fixing bar, and another end of the first case opposite to the first connection sleeve is an open end. The first slide is received in and slidable relative to the first case to be extendable from and retractable into the first case via the open end thereof. According to an operable embodiment of the present invention, the second slide unit includes a second case and a second slide. The second case is provided at an end with a second connection sleeve for movably fitting around the second fixing bar, and another end of the second case opposite to the second connection sleeve is an open end. The second slide is received in and slidable relative to the second case to be extendable from and retractable into the second case via the open end thereof.

According to an operable embodiment of the present invention, the horizontal displacement unit includes a first coupled section, a second coupled section, a first crossbar, a second crossbar, a scissor structure unit, and a horizontal power element. The first coupled section is connected to the first slide and the wheelchair main body. The second coupled section is connected to the second slide and the wheelchair main body. The first crossbar is connected at two opposite ends to the first case of the first slide unit and the second case of the second slide unit, respectively; and the second crossbar is connected at two opposite ends to the first coupled section and the second coupled section, respectively. The scissor structure unit is movably connected to between the first crossbar and the second crossbar, and includes a plurality of intersected first and second link bar sets that are pivotally connected end-to-end. The intersected first and second link bars in each set are pivotally connected to each other at a middle pivot point formed at middle points of the intersected first and second link bars. The scissor structure unit has a first outer side corresponding to the first crossbar and a second outer side corresponding to the second crossbar. The interested first and second link bars that form the first outer side and the intersected first and second link bars that form the second outer side of the scissor structure unit are movably connected at respective outer end to the first crossbar and the second crossbar, respectively, via a movable ring each. The horizontal power element is connected to the lift table of the vertical lift module and the first outer side of the scissor structure unit.

According to an operable embodiment of the present invention, the lift power unit is an electric motor and the horizontal power element can be an air cylinder or a hydraulic cylinder. The horizontal power element includes a barrel connected to the lift table and a piston rod connected to the middle pivot point of the intersected first and second link bars that form the first outer side of the scissor structure unit.

According to an operable embodiment of the present invention, the wheelchair main body includes a seat and back upholstery located above the movement assistive device.

According to an operable embodiment of the present invention, the wheelchair further includes a plurality of wheels. The wheels can be rotatably mounted to the bottom sides of the legs of the base of the vertical lift module, or to two lateral outer sides of the wheelchair main body.

According to an operable embodiment of the present invention, the vertical lift module further includes a manual operation unit connected to the reduction unit.

With the movement assistive device and the wheelchair equipped with same according to the present invention, the wheelchair user or operator can manipulate the wheelchair to move it vertically and horizontally in a much more convenient manner. Therefore, the wheelchair user and operator can overcome the inconvenience encountered by them at places that are not barrier-free for them.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1A is an assembled perspective view of a movement assistive device according to a preferred embodiment of the present invention;

FIG. 1B is an exploded view of FIG. 1A;

FIG. 2A is an exploded perspective view of a vertical lift module included in the movement assistive device of the present invention;

FIG. 2B is an assembled perspective view of the vertical lift module included in the movement assistive device of the present invention but with a differently structured base;

FIG. 3A is an assembled perspective view of a horizontal extension module included in the movement assistive device of the present invention, wherein the horizontal extensions module is in a retracted state;

FIG. 3B shows the horizontal extension module is in an extended state;

FIG. 4A is a front perspective view of a first embodiment of a wheelchair equipped with movement assistive device according to the present invention, wherein a seat and back upholstery of the wheelchair is removed from the drawing;

FIG. 4B is a rear view of the wheelchair of FIG. 4A;

FIG. 4C is a front perspective view of the wheelchair of FIG. 4A with the seat and back upholstery fitted thereon;

FIG. 4D is a front perspective view of a second embodiment of the wheelchair equipped with movement assistive device according to the present invention;

FIG. 5A is a side view of the wheelchair of FIG. 4A before being vertically lifted;

FIG. 5B is a side view of the wheelchair of FIG. 5A after being vertically lifted;

FIG. 5C is a side view of the wheelchair of FIG. 5B after being horizontally displaced onto a second surface;

FIG. 5D is a rear view showing the wheelchair of FIG. 4A with the vertical lift module located below it;

FIG. 5E shows the wheelchair of FIG. 5D with the vertical lift module being manually actuated to start operating;

FIG. 5F is a side view showing the wheelchair of FIG. 5C with the base of the movement assistive device being ascended;

FIG. 5G is a side view showing the wheelchair of FIG. 5F with the horizontal extension module of the movement assistive device being horizontally moved onto the second surface;

FIGS. 6A to 6E illustratively show the manner of actuating the movement assistive device to lift and displace the wheelchair of the present invention onto a carrier;

FIGS. 6F to 6I illustratively show the manner of actuating the movement assistive device to displace and lower the wheelchair of the present invention to a ground surface;

FIG. 7A is a rear view showing the wheelchair of FIG. 6I with the vertical lift module in contact with the ground surface; and

FIG. 7B shows the wheelchair of FIG. 7A with the vertical lift module being returned to its original position below the wheelchair.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

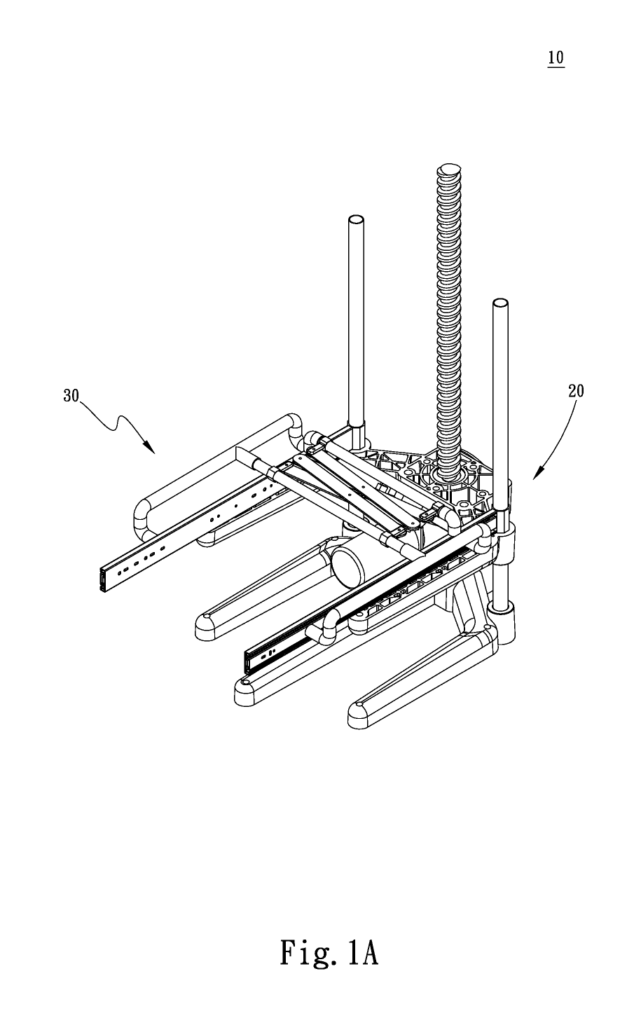

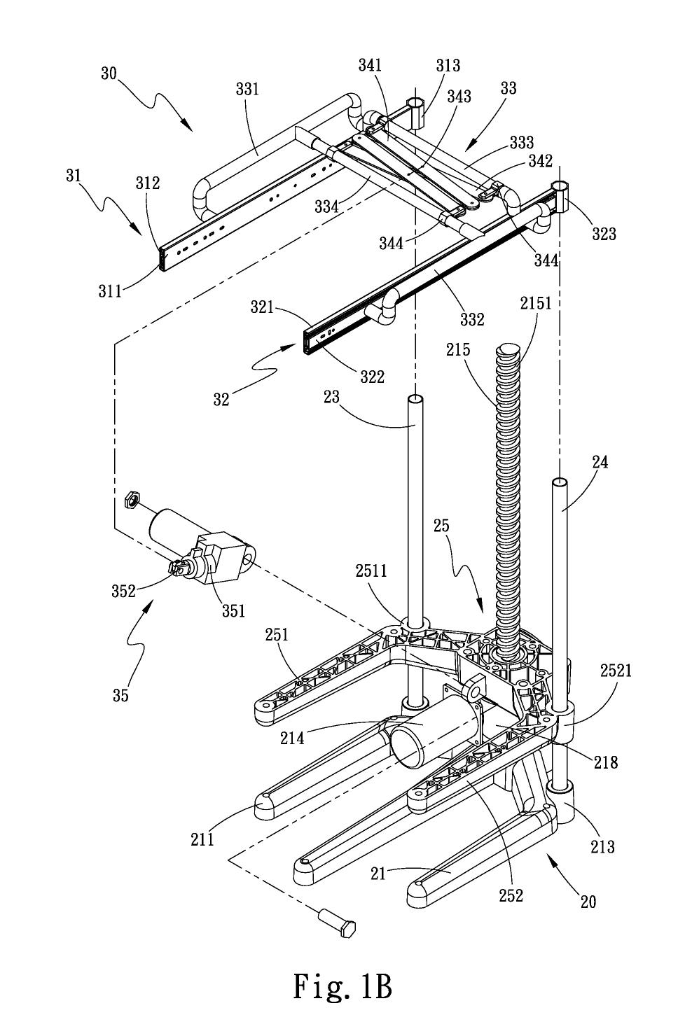

First, the structure of a movement assistive device 10 of the present invention is described in detail below. Please refer to FIGS. 1A and 1B that are assembled and exploded perspective views, respectively, of the movement assistive device 10 according to a preferred embodiment of the present invention. As shown, the movement assistive device 10 includes a vertical lift module 20 and a horizontal extension module 30 located above the vertical lift module 20.

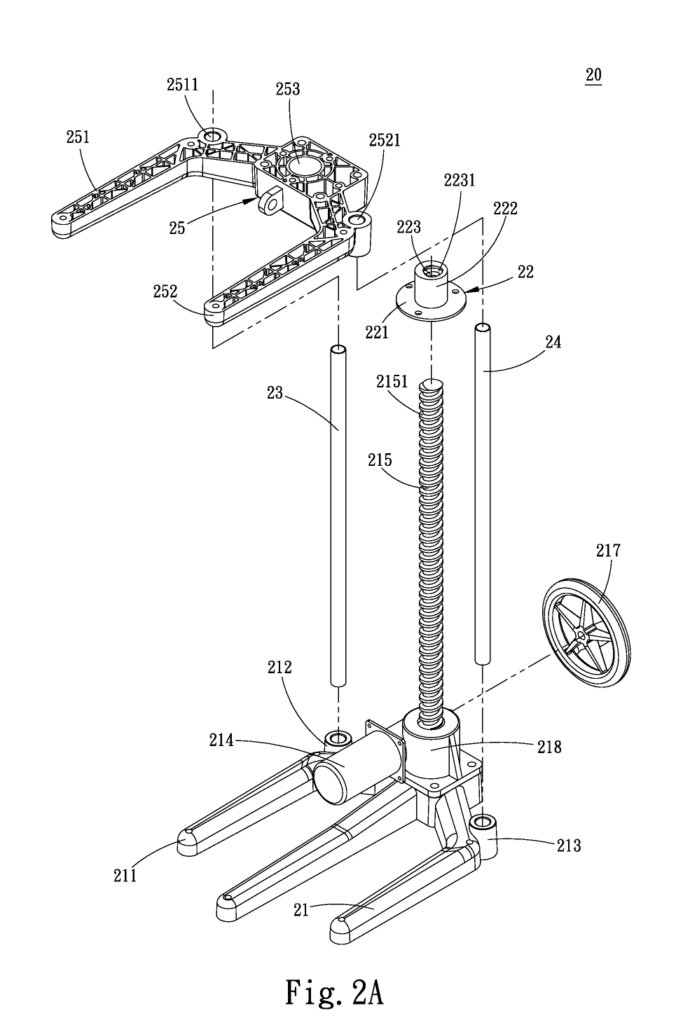

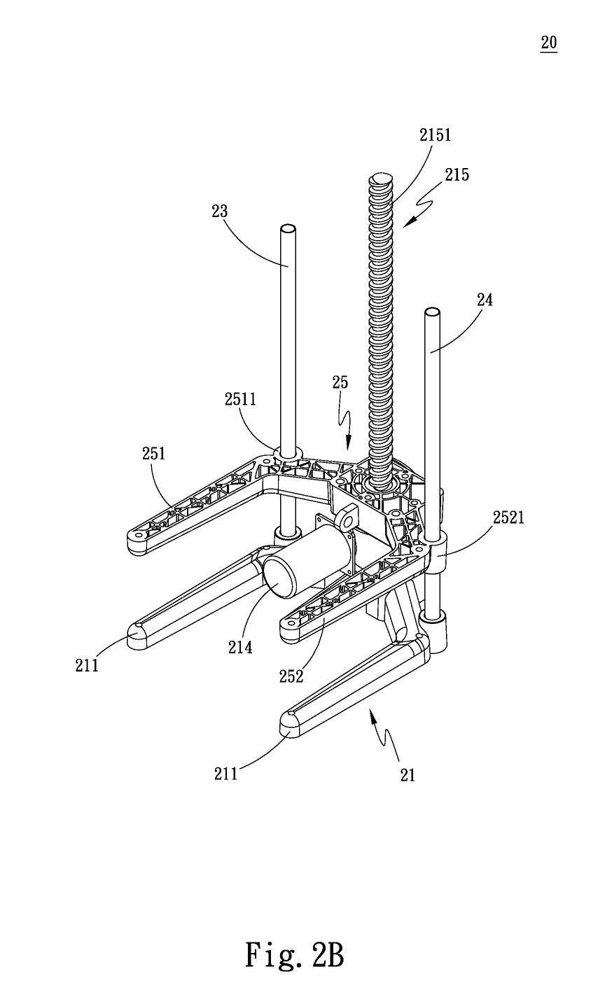

FIG. 2A is an exploded perspective view of the vertical lift module 20. Please refer to FIG. 2A along with FIG. 1B. The vertical lift module 20 includes a base 21, a reduction unit 218, a lift power unit 214, a first fixing bar 23 and a second fixing bar 24, a lift support unit 22, and a lift table 25. The base 21 includes a plurality of legs 211, a first locating sleeve 212, and a second locating sleeve 213. In FIG. 2A, three legs 211 are illustrated. Two of the three legs 211 are located at two lateral sides of the base 21 while the third leg 211 is located between the two lateral legs 21. The first locating sleeve 212 and the second locating sleeve 213 are separately connected to the two lateral legs 211 of the base 21. However, it is understood the number of the legs 211 on the base 21 is not necessarily limited to three but can be decided according to actual need in design. For example, as shown in FIG. 2B, the base 21 includes only two legs 211 that are located at two lateral sides of the base 21. The base 21 can be brought to contact with a ground surface and provide a supporting surface for the whole movement assistive device 10 to stably stand on the ground surface.

The reduction unit 218 is arranged on a top of the base 21 and includes an upright rotational screw rod 215, which is externally threaded to provide an external thread section 2151. The reduction unit 218 is a type of reduction gear for speed reduction, power transmission and torque increase. Generally speaking, the reduction unit 218 is an assembly of transmission parts, such as gears or worm screws, a shaft, bearings, a case, and other accessories. By meshing a fewer-teeth gear on an input shaft of the reduction unit 218 with a larger gear on an output shaft of the reduction unit 218, the rotational speed of an engine, an internal combustor, a motor or other high-speed rotating power can be reduced. The ratio of the small input gear's tooth number to the large output gear's tooth number, i.e. the gear ratio, is also the transmission ratio. In the illustrated preferred embodiment of the present invention, the input shaft (i.e. an input end) of the reduction unit 218 is connected to the lift power unit 214, and the output shaft (i.e. an output end) of the reduction unit 218 is the rotational screw rod 215.

The lift power unit 214 is preferably an electric motor but is not necessarily limited thereto. A manual operation unit 217 is connected to the input shaft, or the input end, of the reduction unit 218, allowing a user to manually actuate the rotational screw rod 215 of the reduction unit 218. The manual operation unit 217 is a backup design to be used when the lift power unit 214 runs out of power.

The first fixing bar 23 and the second fixing bar 24 are vertically downwardly inserted into the first locating sleeve 212 and the second locating sleeve 213, respectively, so as to locate at two lateral outer sides of the rotational screw rod 215 and be parallel to the latter.

The lift support unit 22 includes a flange portion 221, a sleeve portion 222 upward projected from a center of the flange portion 221, and a bore 223 axially extended through the sleeve portion 222 and the flange portion 221. The bore 223 is internally threaded to provide an internal thread section 2231 for meshing with the external thread section 2151 of the rotational screw rod 215. The lift support unit 22 is externally fitted around the rotational screw rod 215 with the internal thread section 2231 in the bore 223 meshed with the external thread section 2151 of the rotational screw rod 215. Therefore, when the rotational screw rod 215 is rotated, the lift support unit 22 is brought to move on along the rotational screw rod 215. That is, the lift support unit 22 is vertically straightly movable upward and downward on along the rotational screw rod 215.

The lift table 25 includes a central hole 253 that extends through the lift table 25 in a thickness direction thereof. The central hole 253 has an inner diameter larger than an outer diameter of the sleeve portion 222 of the lift support unit 22, so that the lift table 25 can be supported on the flange portion 221 of the lift support unit 22 with the central hole 253 externally fitted around the sleeve portion 222. That is, the lift table 25 has a bottom surface in contact with a top surface of the flange portion 221. Whereby, when the lift support unit 22 vertically straightly moves upward or downward on along the rotational screw rod 215, the lift table 25 is brought to move along with the lift support unit 22. A first supporting arm 251 and a second supporting arm 252 are located at two lateral sides of the lift table 25. The first supporting arm 251 has a first locating hole 2511 provided thereon for movably fitting around the first fixing bar 23, and the second supporting arm 252 has a second locating hole 2521 provided thereon for movably fitting around the second fixing bar 24, so as to ensure that the lift table 25 would not rotate while moving upward or downward.

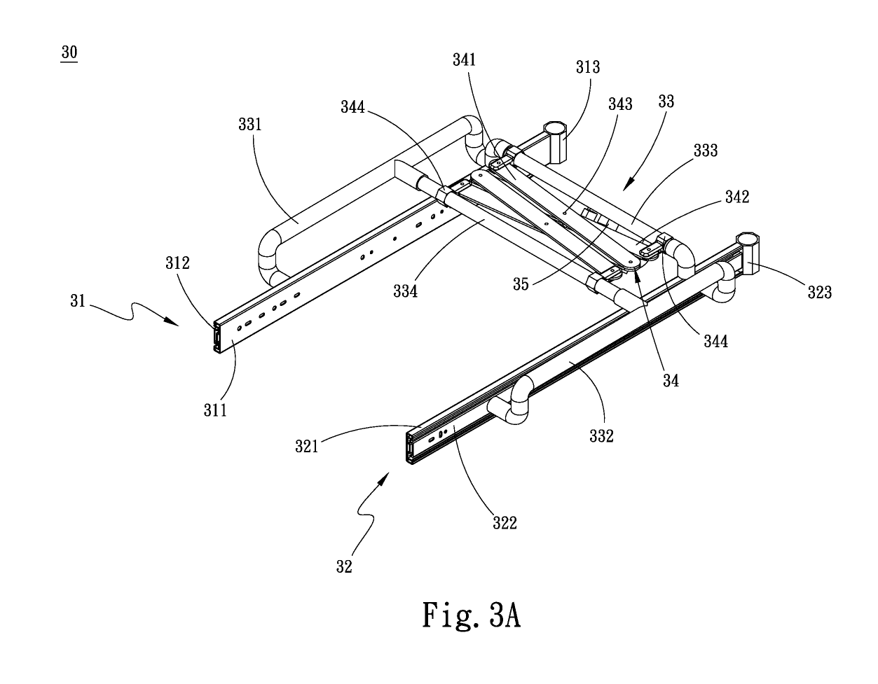

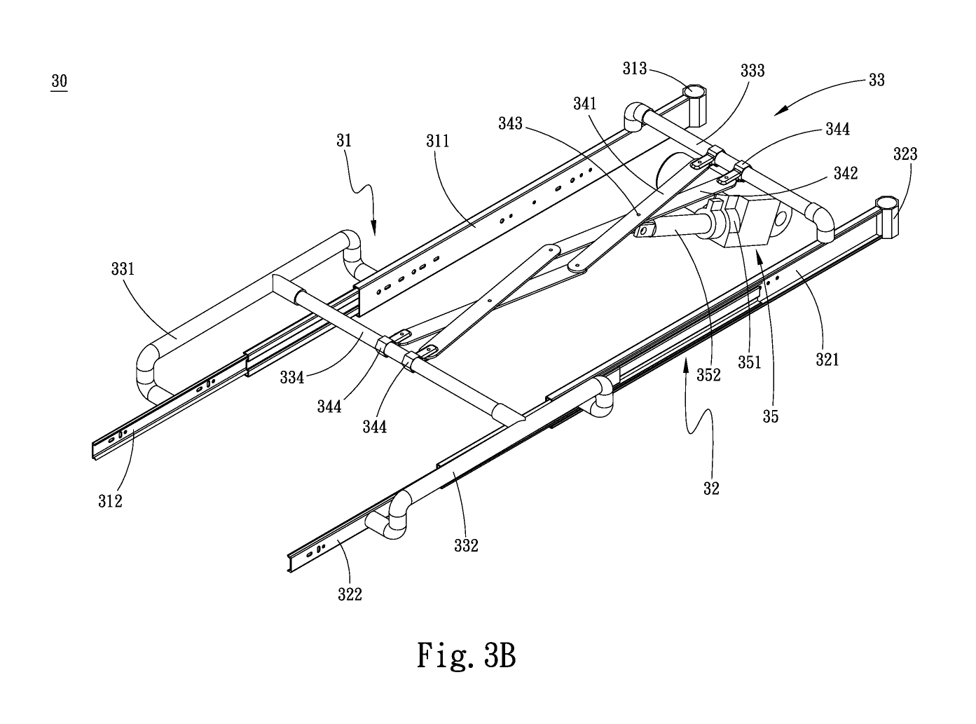

FIG. 3A is an assembled perspective view showing the horizontal extension module 30 in a retracted state, and FIG. 3B shows the horizontal extension module 30 in an extended state. Herein, one of the retracted state and the extended state is the first state, and the other is the second state. Please refer to FIGS. 3A and 3B along with FIG. 1B. The horizontal extension module 30 includes a first slide unit 31 and a second slid unit 32, which are spaced from and parallel to each other; and a horizontal displacement unit 33 located between and connected to the first and the second slide unit 31, 32.

The first slide unit 31 and the second slide unit 32 are arranged atop the lift table 25, as shown in FIG. 1B, and are preferably in the form of linear slide rails, such as multi-section ball slide rails. The first slide unit 31 includes a first case 311 and a first slide 312. The first case 311 is provided at an end with a first connection sleeve 313 for movably fitting around the first fixing bar 23. Another end of the first case 311 opposite to the first connection sleeve 313 is an open end. The first slide 312 is received in and slidable relative to the first case 311, and can therefore be extended from or retracted into the first case 311 via the open end thereof. The second slide unit 32 includes a second case 321 and a second slide 322. The second case 321 is provided at an end with a second connection sleeve 323 for movably fitting around the second fixing bar 24. Another end of the second case 321 opposite to the second connection sleeve 323 is an open end. The second slide 322 is received in and slidable relative to the second case 321, and can therefore be extended from or retracted into the second case 321 via the open end thereof.

The horizontal displacement unit 33 includes a first coupled section 331 connected to the first slide 312, a second coupled section 332 connected to the second slide 322, a first crossbar 333, a second crossbar 334 parallel spaced from the first crossbar 333, a scissor structure unit 34, and a horizontal power element 35. The first crossbar 333 is connected at two opposite ends to the first case 311 of the first slide unit 31 and the second case 321 of the second slide unit 32, respectively. The second crossbar 334 is connected at two opposite ends to the first coupled section 331 and the second coupled section 332, respectively.

The scissor structure unit 34 is movably connected to between the first crossbar 333 and the second crossbar 334. The scissor structure unit 34 includes a plurality of sets of intersected first and second link bars 341, 342, and the intersected first and second link bar sets are pivotally connected end-to-end. The intersected first and second link bars 341, 342 in each set are pivotally connected to each other at a middle pivot point 343 formed at middle points of the intersected first and second link bars 341, 342. The scissor structure unit 34 has a first outer side corresponding to the first crossbar 333 and a second outer side corresponding to the second crossbar 334. The intersected first and second link bars 341, 342 that form the first outer side and the intersected first and second link bars 341, 342 that form the second outer side of the scissor structure unit 34 are movably connected at respective outer end to the first crossbar 333 and the second crossbar 334, respectively, via a movable ring 344 each, such that the outer ends of the intersected first and second link bars 341, 342 connected to the movable rings 344 can move along the first or the second crossbar 333, 334 toward or away from each other.

The horizontal power element 35 can be an air cylinder or a hydraulic cylinder, either power-operated or manually operated, and includes a barrel 351 connected to the lift table 25, and a piston rod 352 connected to the middle pivot point 343 of the intersected first and second link bars that form the first outer side of the scissor structure unit 34, as can be clearly seen in FIGS. 1B, 3A and 3B. The piston rod 352 is extendable from or retractable into the barrel 351 when being driven by air pressure or hydraulic pressure.

As shown in FIG. 3B, when the piston rod 352 of the horizontal power element 35 is extended from the barrel 351, it drives the scissor structure unit 34 and brings the intersected first and second link bars 341, 342 in each set to turn about the middle pivot point 343 and accordingly move toward each other in the same plane into an almost straight line. Meanwhile, the movable rings 344 connecting the sets of the intersected first and second link bars 341, 342 to each of the first and the second crossbar 333, 334 also move toward each other on along the first and the second crossbar 333, 334. At this point, the second crossbar 334 is brought by the linearly extended scissor structure unit 34 to move in a direction away from the first crossbar 333, so that a distance between the first and the second crossbar 333, 334 is increased. Meanwhile, the second crossbar 334 brings the first and the second coupled section 331, 332 connected thereto to horizontally move along with it in the same direction. Further, the first slide 312 of the first slide unit 31 and the second slide 322 of the second slide unit 32 are also brought by the first and the second coupled section 331, 332, respectively, to slide from a first position, which is a retracted position in the first and the second case 311, 321, to a second position, which is an extended position beyond the open end of the first and the second slide unit 31, 32.

When the piston rod 352 of the horizontal power element 35 is pulled back into the barrel 351, it drives the sets of the intersected first and second link bars 341, 342 of the scissor structure unit 34 to turn about the middle pivot points 343 in the same plane, so that all the pivotally connected first and second link bars 341, 342 are moved back to the original folded position. Meanwhile, the movable rings 344 connecting the intersected first and second link bars 341, 342 to each of the first and the second crossbar 333, 334 also move away from each other on along the first and the second crossbar 333, 334. At this point, the second crossbar 334 is brought by the linearly folded scissor structure unit 34 to move in a direction toward the first crossbar 333, so that the distance between the first and the second crossbar 333, 334 is shortened. Meanwhile, the second crossbar 334 brings the first and the second coupled section 331, 332 connected thereto to horizontally move along with it in the same direction. Further, the first slide 312 of the first slide unit 31 and the second slide 322 of the second slide unit 32 are also brought by the first and the second coupled section 331, 332, respectively, to slide from the second position, i.e. the extended position beyond the open end of the first and the second slide unit 31, 32, to the first position, i.e. the retracted position in the first and the second case 311, 321, as shown in FIG. 3A.

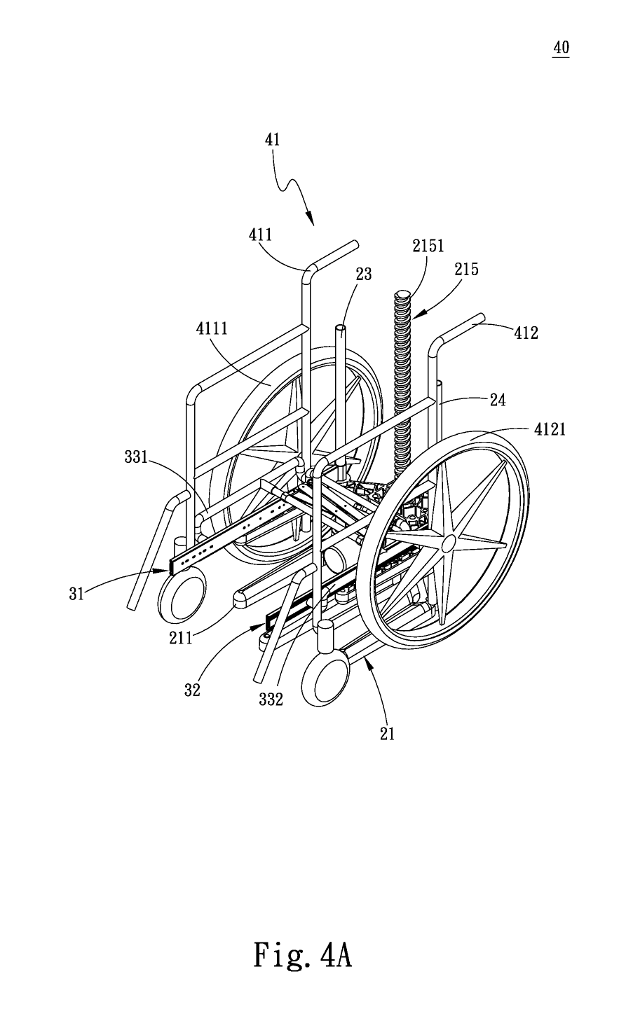

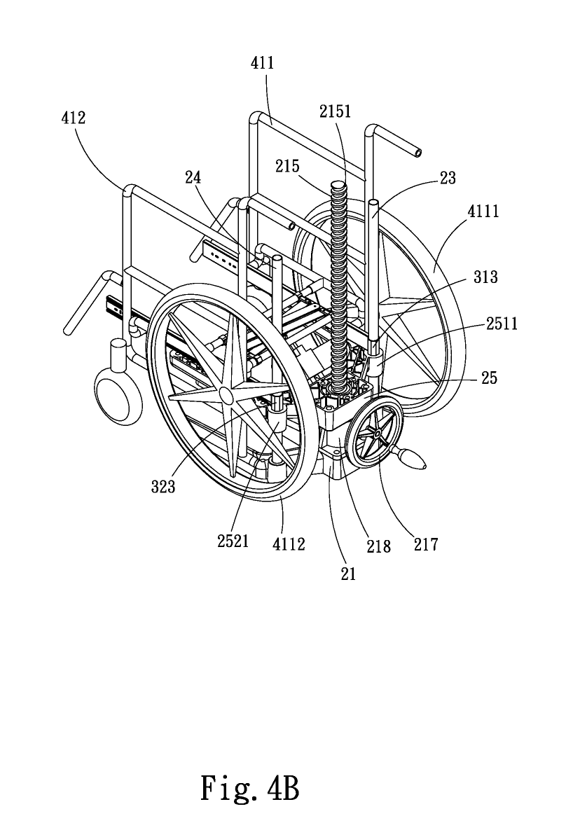

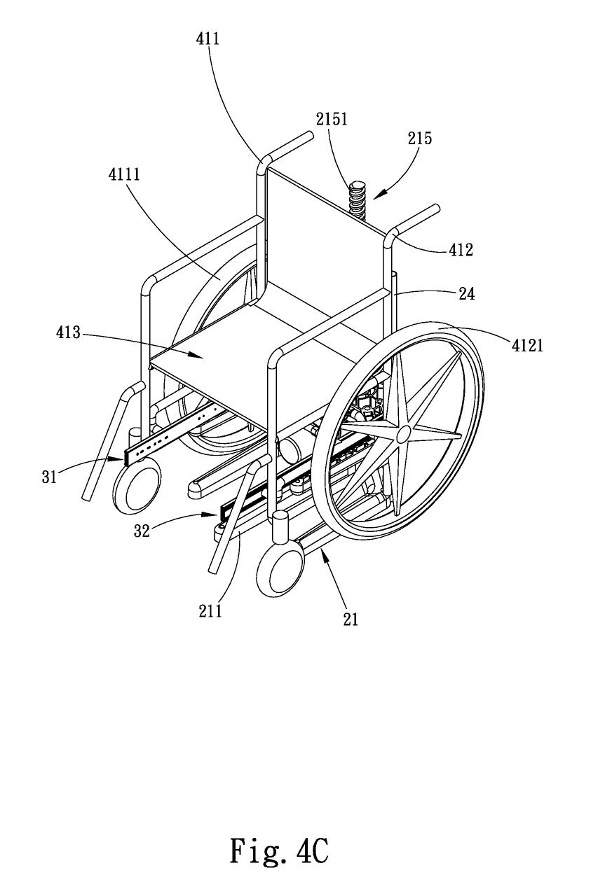

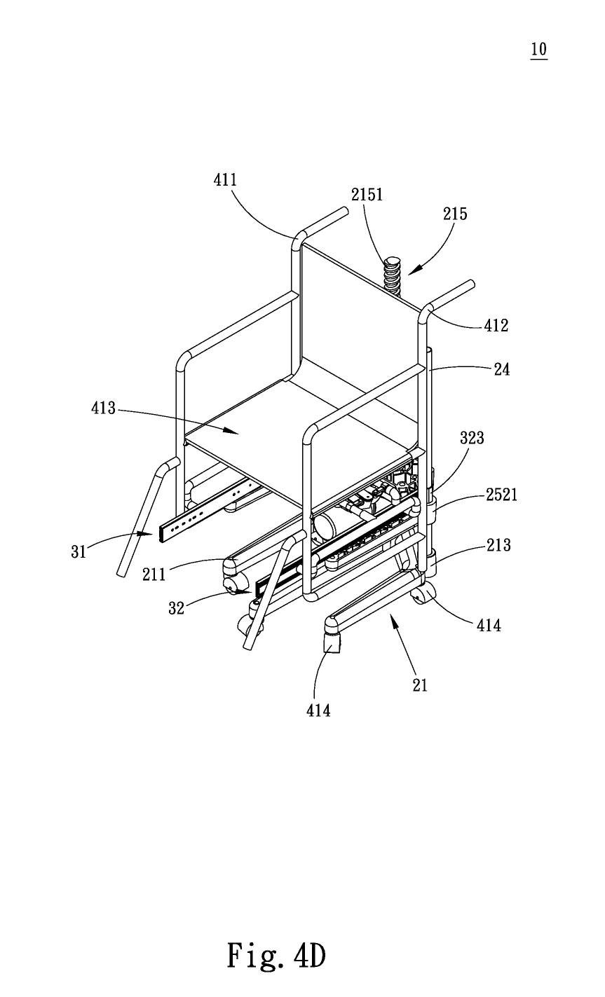

A wheelchair equipped with movement assistive device according to the present invention is described in detail below. FIGS. 4A and 4B are front and rear perspective views of a first embodiment of the wheelchair equipped with movement assistive device according to the present invention, which is also briefly referred to as the wheelchair herein for the purpose of conciseness and clarity. Please refer to FIGS. 4A and 4B along with FIGS. 2A, 2B, 3A and 3B. The wheelchair of the present invention is generally denoted by reference numeral 40, and includes a wheelchair main body 41 and a movement assistive device 10. The wheelchair main body 41 includes a first frame 411 and a second frame 412, which are laterally corresponding to but spaced from each other. In the illustrated embodiment, the first and the second frame 411, 412 are shown as laterally symmetrical to each other. A first wheel 4111 is rotatably mounted to the first frame 411, and a second wheel 4121 is rotatably mounted to the second frame 412. With the aid of the first and second wheel 4111, 4121, the wheelchair main body 41 can be moved.

The movement assistive device 10 is the device having been described in previous paragraphs with reference to FIGS. 1A to 3B. It is mounted between the first and the second frame 411, 412 with the first and the second coupled section 331, 332 of the horizontal displacement unit 33 connected to the first and the second frame 411, 412, respectively, so that the movement assistive device 10 and the wheelchair main body 41 form an integral unit. The first and the second coupled section 331, 332 of the horizontal displacement unit 33 can be connected to the first and the second frame 411, 412, respectively, by a mechanical process, including but not limited to welding, riveting, screw-fastening and the like.

The wheelchair 40 of the present invention of FIGS. 4A and 4B further includes a seat and back upholstery 413, as shown in FIG. 4C. The seat and back upholstery 413 is connected to between the first and the second frame 411, 412 and is located above the movement assistive device 10 for a user to sit thereon when operating the wheelchair 40.

FIG. 4D shows another embodiment of the wheelchair 40 according to the present invention. For the wheelchair 40 to be conveniently usable in a somewhat narrow space, the first and the second wheel 4111, 4121 mounted to the first and the second frame 411, 412, respectively, as shown in FIGS. 4A and 4B, can be omitted and replaced with a plurality of small-sized third wheels 414. The third wheels 414 are mounted to bottom sides of the legs 211 of the base 21 of the movement assistive device 10, so as to aid the wheelchair 40 to move.

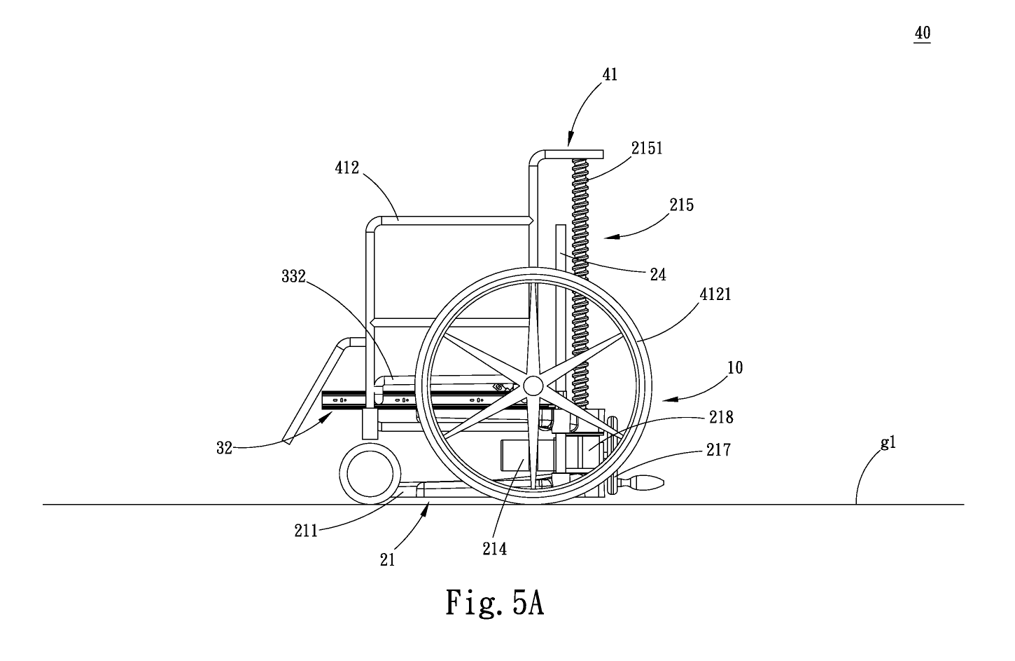

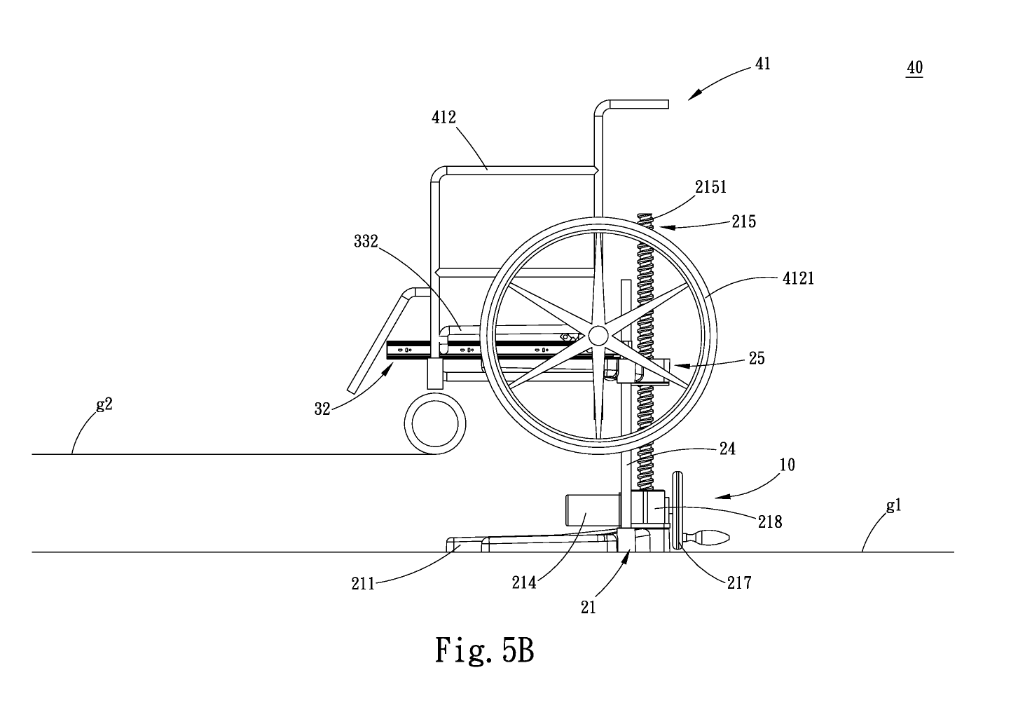

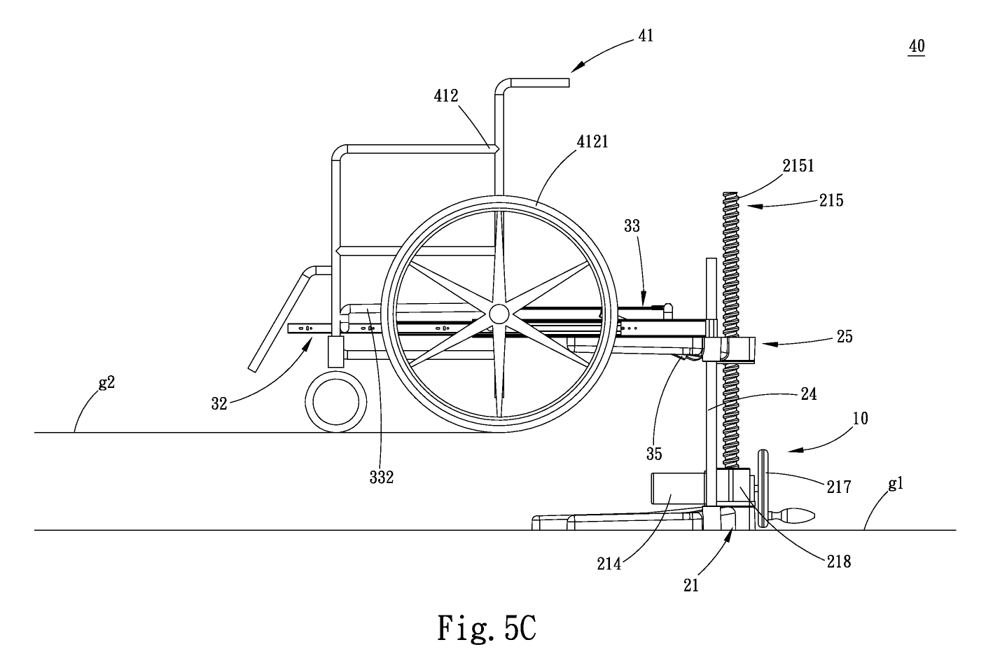

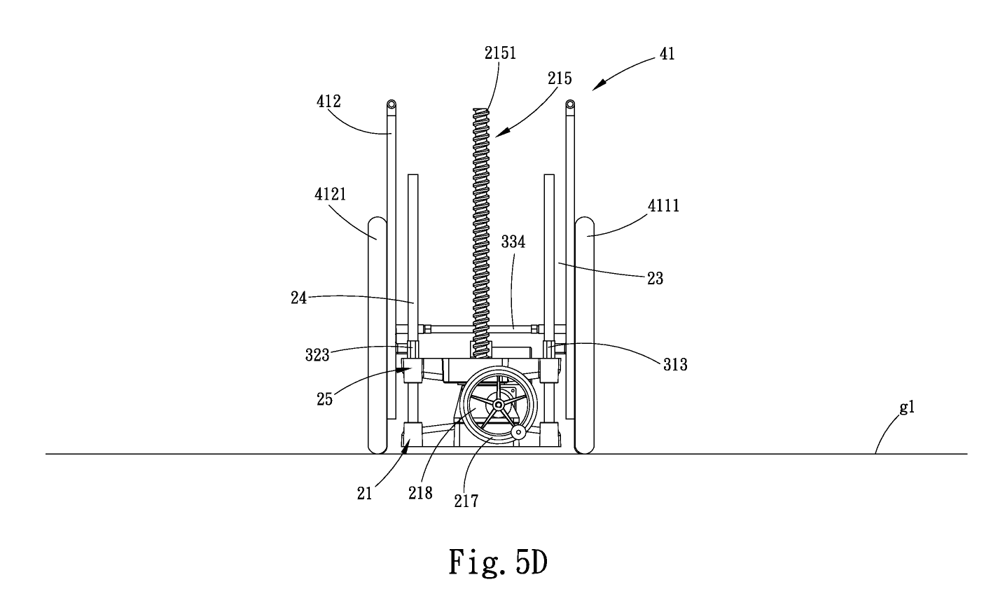

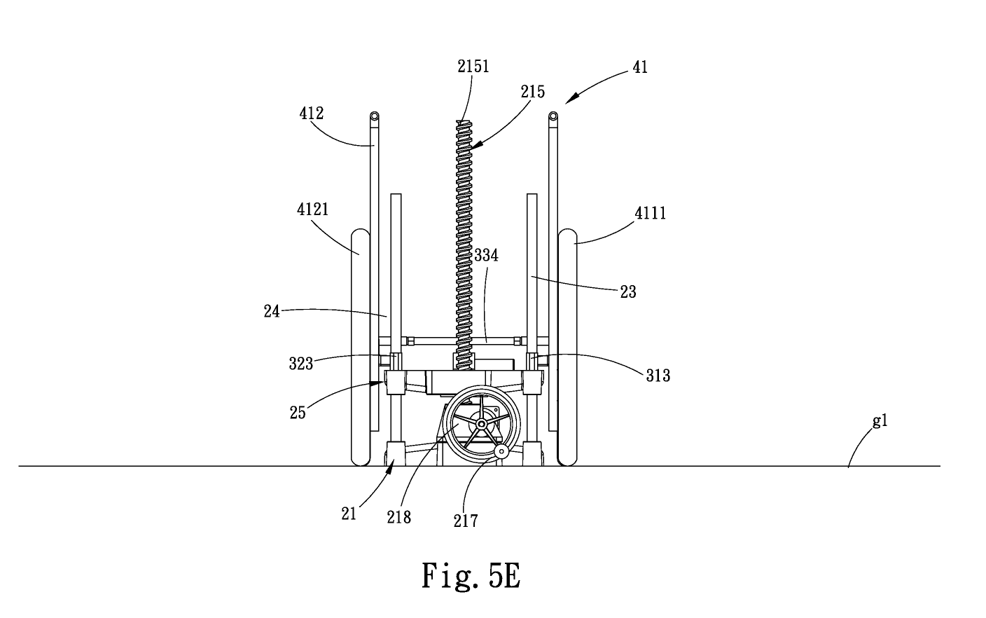

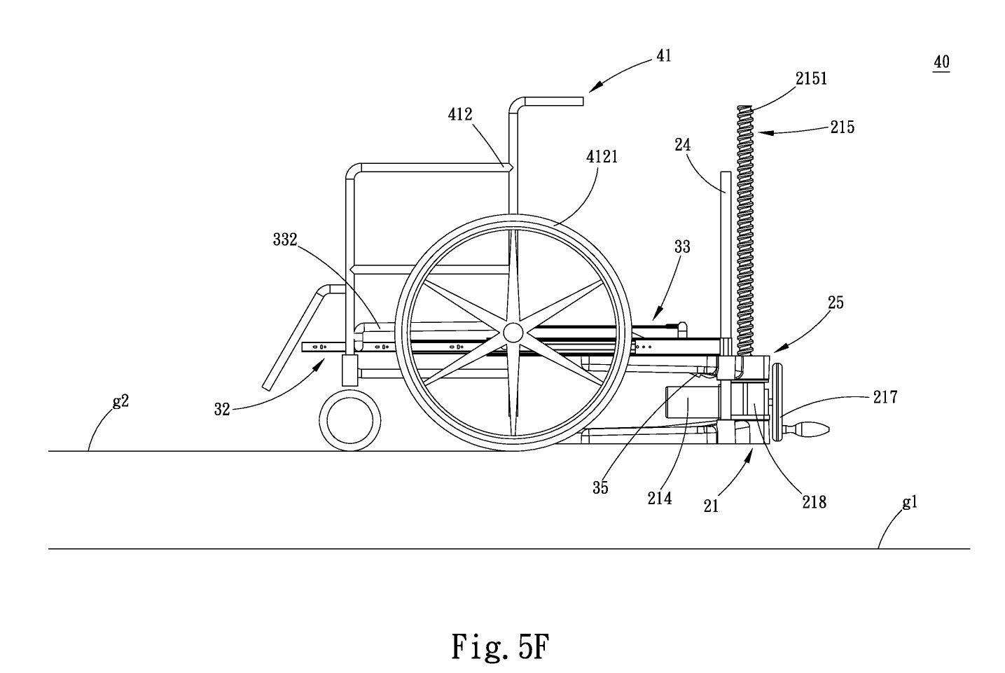

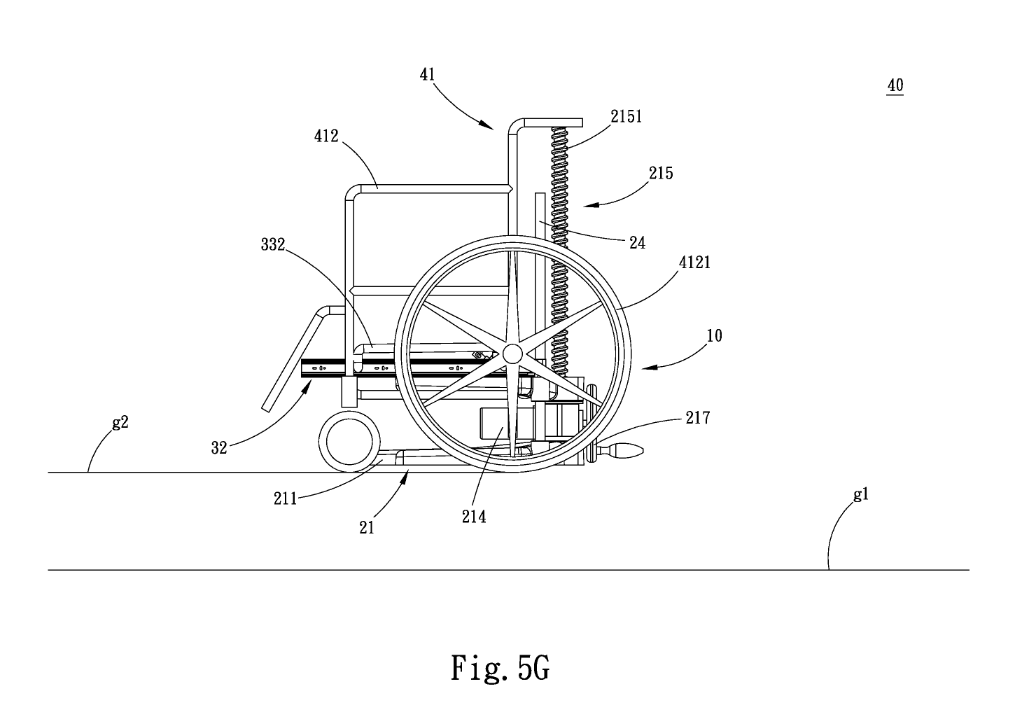

The operation of the wheelchair equipped with movement assistive device is now described in detail as below. Please refer to FIGS. 5A to 5G along with FIGS. 1A to 4C. FIG. 5A is a side view of the wheelchair 40 before being vertically lifted; FIG. 5B is a side view of the wheelchair 40 after being vertically lifted; FIG. 5C is a side view of the wheelchair 40 after being vertically lifted and horizontally displaced onto a second surface; FIG. 5D is a rear view showing the wheelchair 40 with the vertical lift module 20 located below it; FIG. 5E shows the wheelchair 40 with the vertical lift module 20 being manually actuated to start operating; FIG. 5F is a side view showing the wheelchair 40 with the base 21 of the movement assistive device 10 being ascended; and FIG. 5G is a side view showing the wheelchair 40 with the horizontal extension module 30 of the movement assistive device 10 being horizontally moved onto the second surface.

As shown in FIG. 5A, when the wheelchair 40 is supported by the first and the second wheel 4111, 4121 to operate on a first surface g1, such as the ground surface, the movement assistive device 10 located below the wheelchair 40 has a bottom side, i.e. the bottom side of the base 21, located slightly higher than the first surface g1. That is, the movement assistive device 10 does not contact with the first surface g1, as can be seen also in FIG. 5D. Therefore, when the wheelchair 40 moves on the first surface g1, it would not be hindered by the movement assistive device 10.

As shown in FIG. 5B, when the wheelchair 40 stops moving and stays on the first surface g1, the lift power unit 214 of the movement assistive device 10 is actuated to drive the rotational screw rod 215 to rotate, so that the base 21 is descended onto the first surface g1. In the event the lift power unit 214 runs out of power and is inactive, the manual operation unit 217 can be used to descend the base 21, as shown in FIGS. 5D and 5E. When the base 21 is descended onto the first surface g1, the rotational screw rod 215 is continuously rotated, so that the lift support unit 22 vertically linearly moves upward on along the rotational screw rod 215 through the engagement of the internal thread section 2231 with the external thread section 2151. The lift table 25 and the horizontal extension module 30 are brought upward by the lift support unit 22, and the wheelchair main body 41 is lifted along with the horizontal extension module 30 to vertically linearly move from a lower position to a higher position that is located at the same height of a second surface g2, such as a floor in a carrier.

As shown in FIG. 5C, when the wheelchair main body 41 is lifted to the higher position, the lift power unit 214 stops operating and the horizontal extension module 30 starts operating. At this point, the horizontal power element 35 drives the piston rod 352 to extend from the barrel 351 for driving the scissor structure unit 34 to move, so that the intersected first and second link bars 341, 342 of the scissor structure unit 34 rotate about the middle pivot points 343 to move toward each other in the same plane into an almost straight line. Meanwhile, the movable rings 344 connecting the sets of intersected first and second link bars 341, 342 to each of the first and the second crossbar 333, 334 also move toward each other on along the first and the second crossbar 333, 334. At this point, the second crossbar 334 is brought by the linearly extended scissor structure unit 34 to move in a direction away from the first crossbar 333, so that a distance between the first and the second crossbar 333, 334 is increased. Meanwhile, the second crossbar 334 brings the first and the second coupled section 331, 332 connected thereto to horizontally move along with it in the same direction. Further, the first slide 312 of the first slide unit 31 and the second slide 322 of the second slide unit 32 are also brought by the first and the second coupled section 331, 332, respectively, to slide from the first position to the second position. Therefore, the first and second wheels 4111, 4121 on the wheelchair main body 41 are displaced to rest on the second surface g2.

Then, as shown in FIG. 5F, when the wheelchair main body 41 is rested on the second surface g2, the horizontal power element 35 stops operating, and the lift power unit 214 of the vertical lift module 20 of the movement assistive device 10 drives the rotational screw rod 215 to rotate, so that the base 21 is brought by the rotational screw rod 215 to the higher position, too.

Finally, as shown in FIG. 5G, when the base 21 is lifted to the higher position, the lift power unit 214 stops operating, and the horizontal power element 35 drives the horizontal displacement unit 33 for the first slide 312 of the first slide unit 31 and the second slide 322 of the second slide unit 32 to move from the second position to the first position, so that the base 21 is received below the wheelchair main body 41 and located on the second surface g2.

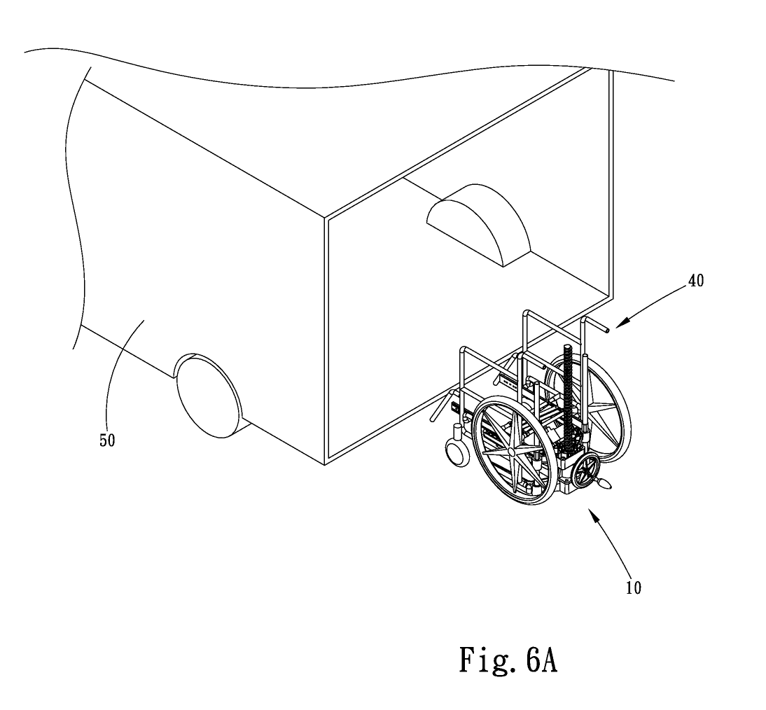

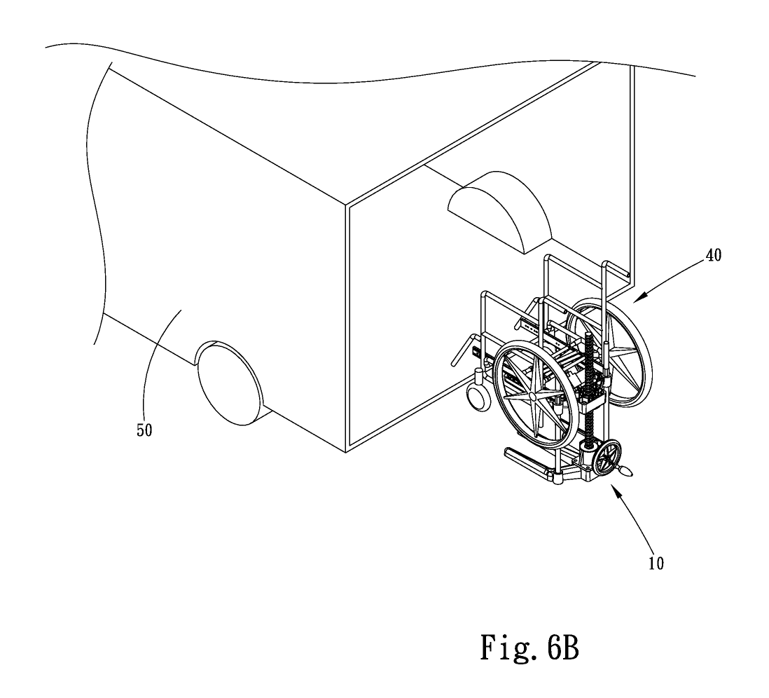

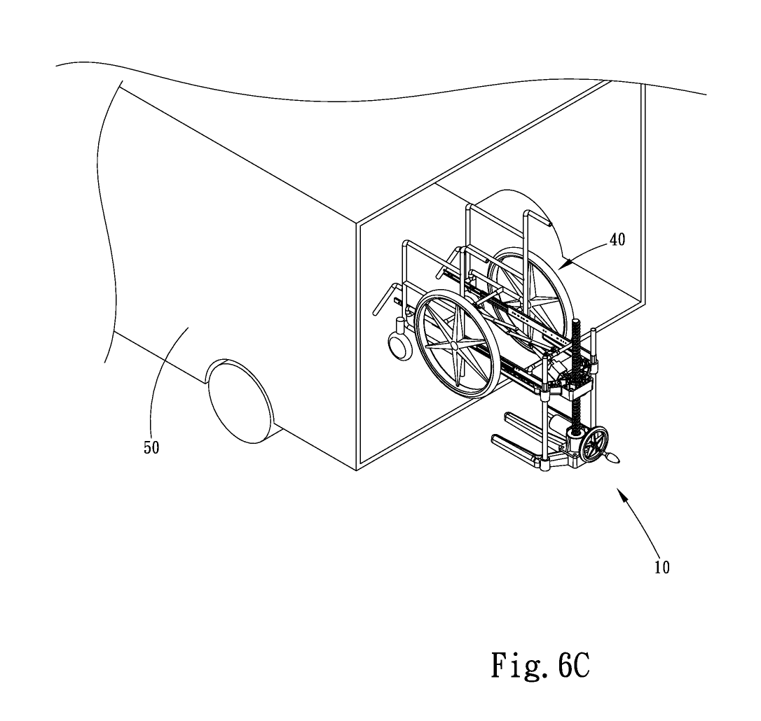

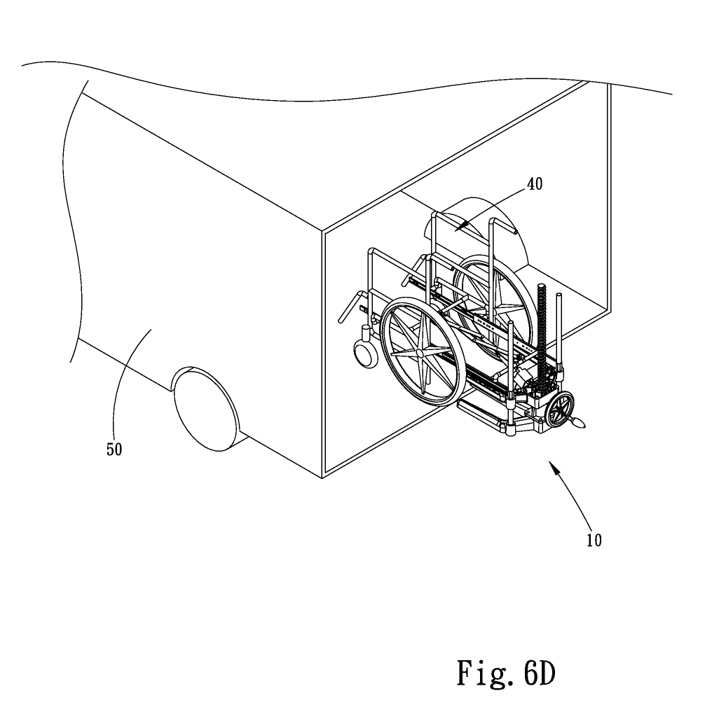

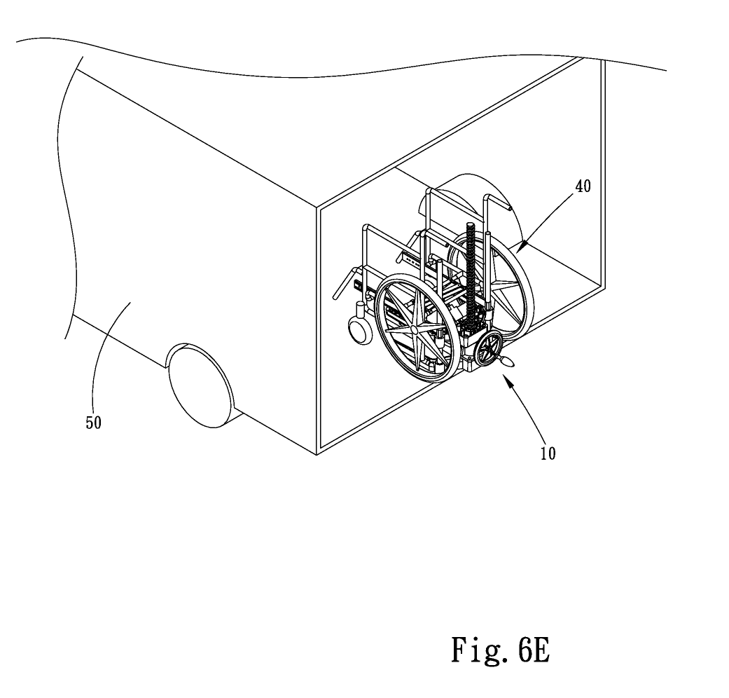

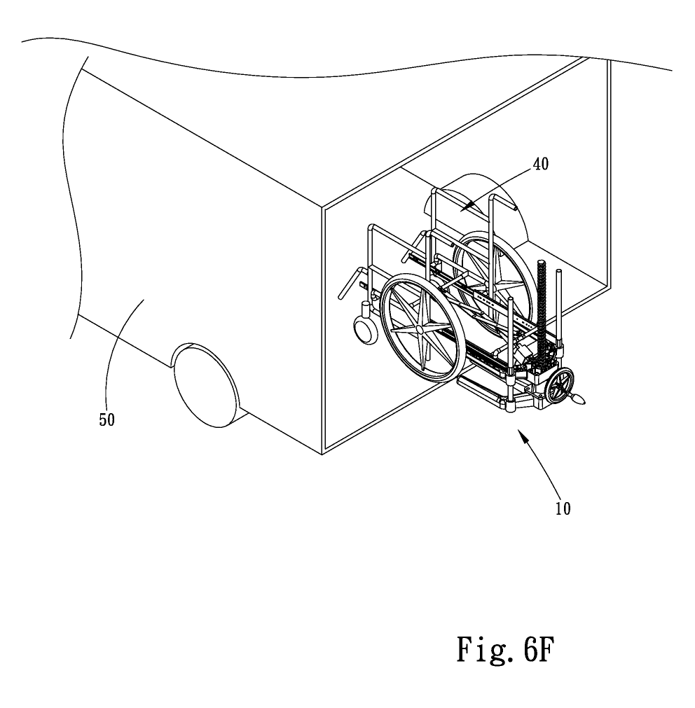

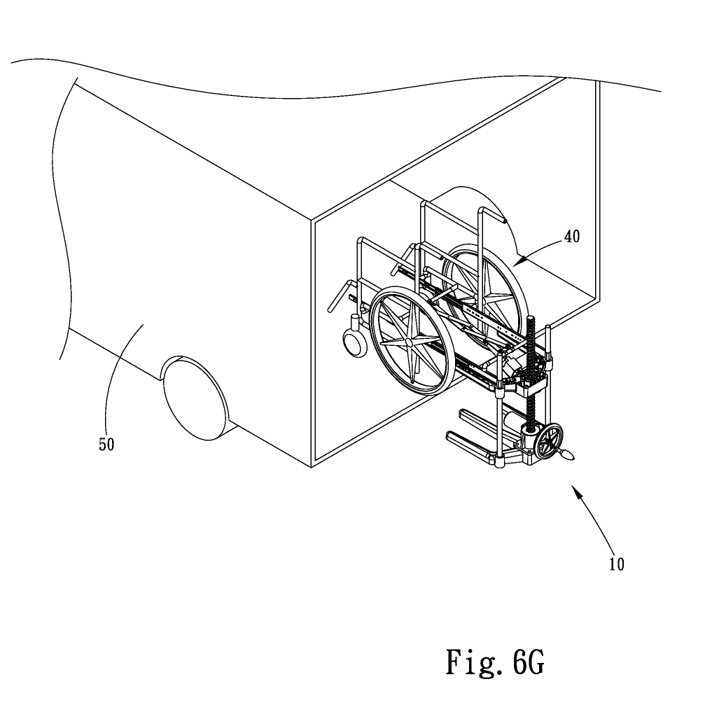

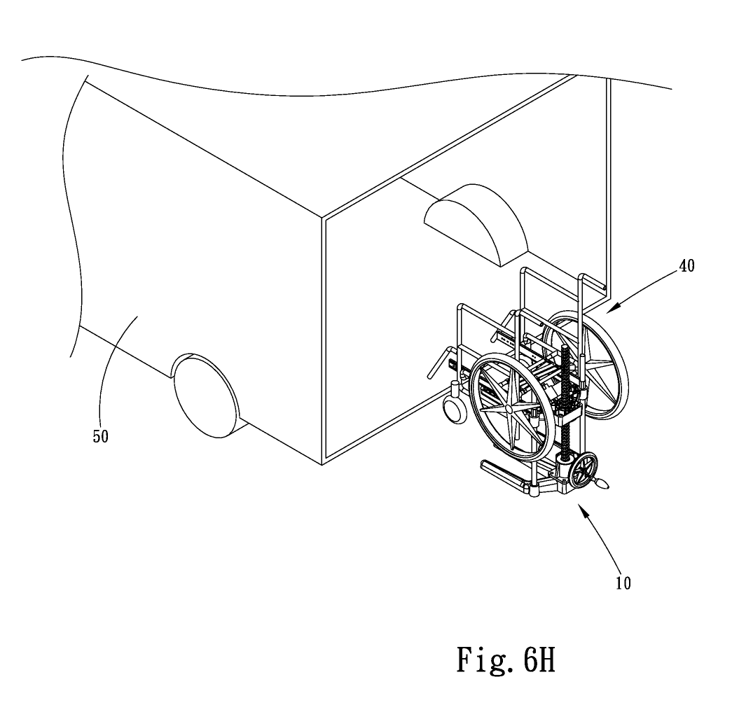

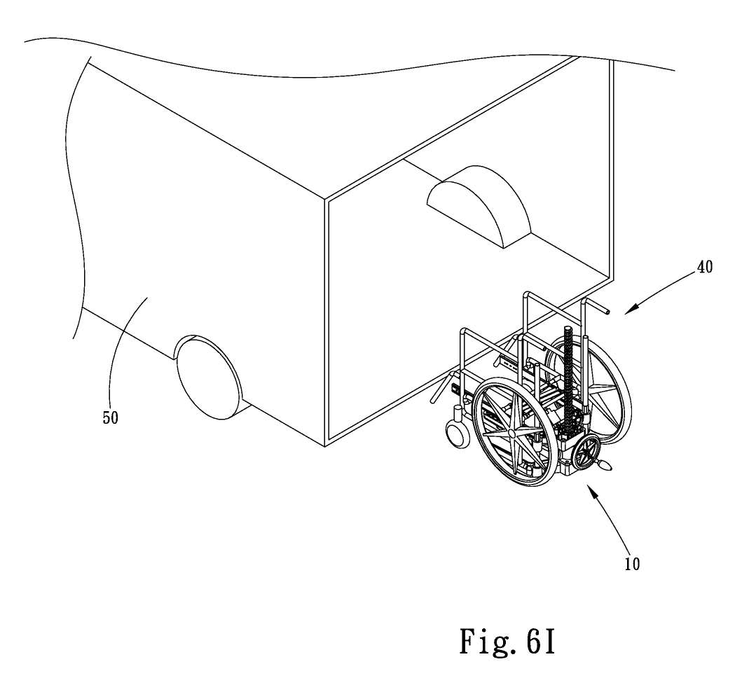

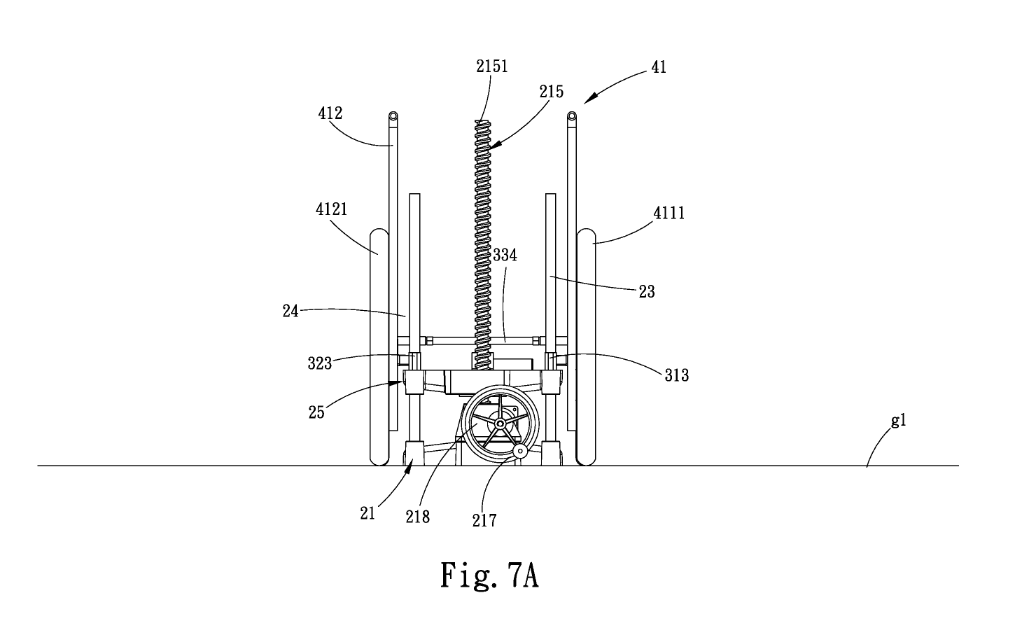

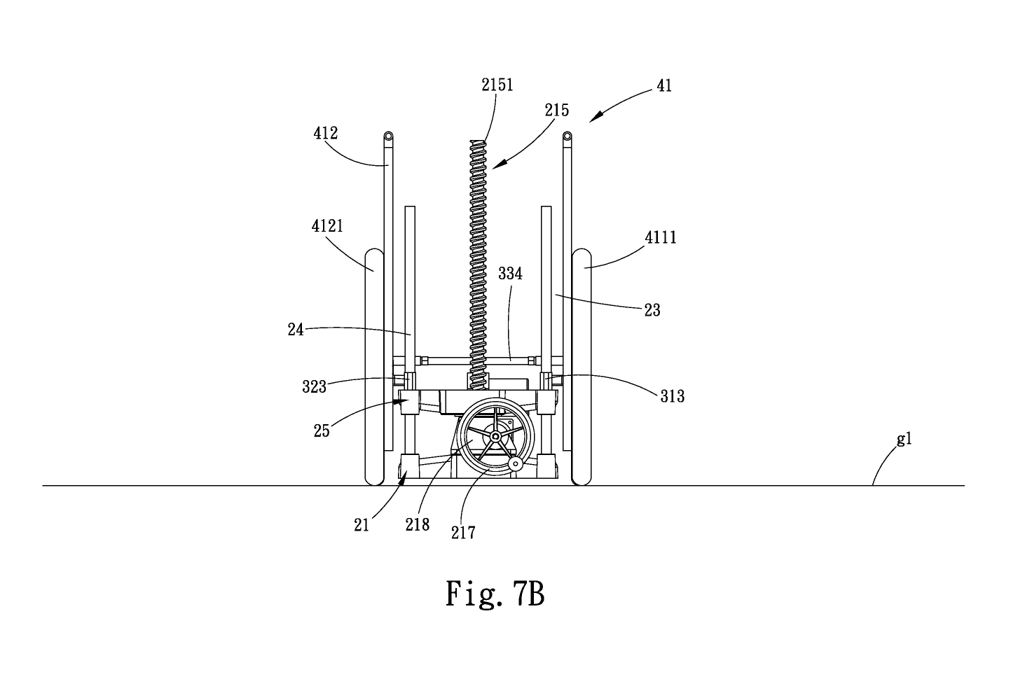

An example of moving the wheelchair 40 equipped with the movement assistive device 10 onto and off a carrier 50 is described in detail as below. Please refer to FIGS. 6A to 6I and FIGS. 7A and 7B. FIGS. 6A to 6E illustratively show the manner of actuating the movement assistive device 10 to lift and displace the wheelchair 40 onto the carrier 50; FIG. 7A is a rear view showing the wheelchair 40 with the vertical lift module 20 being descended to contact with the ground surface g1; and FIG. 7B shows the wheelchair 40 with the vertical lift module 20 being returned to its original position below the wheelchair 40.

Please refer to FIGS. 6A to 6E along with FIGS. 1A to 4C and 5A to 5G. The present invention is developed to enable a user (not shown) sitting on a wheelchair 40 to easily and conveniently move the wheelchair 40 from the ground surface to a carrier 50 and from the carrier 50 to the ground surface. The carrier 50 is generally referred to a road vehicle, but it can also be any other vehicles, such as an airplane or a vessel. Since a floor of the carrier 50 is higher than the ground surface, the wheelchair 40 is moved from the lower ground surface to the higher carrier floor with the aid of the movement assistive device 10. As shown in FIG. 6A, to move the wheelchair 40 onto the carrier 50, first orient the wheelchair 40 to an interior of the carrier 50. Then, as shown in FIG. 5B, operate the movement assistive device 10 to vertically lift the wheelchair 40 to a proper height, that is, the height of the carrier's floor. Then, as shown in FIG. 6C, horizontally displace the wheelchair 40 into the carrier 50. Thereafter, as shown in FIG. 6D, ascend the movement assistive device 10 to another proper height slightly higher than the carrier's floor. Finally, horizontally move the movement assistive device 10 into the carrier 50 to locate it below the wheelchair 40 but slightly higher than the carrier's floor.

Please refer to FIGS. 6F to 6I and FIGS. 7A and 7B along with FIGS. 1A to 4C and 5A to 5G. To move the wheelchair 40 from the carrier 50 to the ground surface, first keep the wheelchair 40 unmovable on the carrier 50 and then actuate the horizontal power element 35 of the horizontal displacement unit 33 of the horizontal extension module 30 of the movement assistive device 10 to horizontally move the movement assistive device 10 relative to the wheelchair main body 41 to a position outside the carrier 50, as shown in FIG. 6F. Then, stop the horizontal power element 35 and actuate the lift power unit 214 of the vertical lift module 20 to vertically descend the base 21 to the ground surface, as shown in FIG. 6G. Thereafter, stop the lift power unit 214 and actuate the horizontal power element 35 again to drive the horizontal displacement unit 33, so as to horizontally move the wheelchair 40 out of the carrier 50, as shown in FIG. 6H. Finally, stops the horizontal power element 35 and actuate the lift power unit 214 again to lower the lift table 25 of the vertical lift module 20, so that the wheelchair 40 moves along with the lift table 25 downward to the ground surface g1, as shown in FIGS. 6I and 7A. When the first and second wheels 4111, 4121 of the wheelchair 40 contact with the ground surface, the base 21 of the movement assistive device 10 is slightly ascended from the ground surface g1, as shown in FIG. 7B, so that the base 21 does not interfere with the wheelchair's movement.

According to the present invention, the movement assistive device 10 can be removably assembled to the wheelchair 40 completely depending on the user's actual need in use. In other words, the movement assistive device 10 can be freely disassembled from the wheelchair 40. When the wheelchair user uses the wheelchair 40 outdoors without the need of getting on or off a vehicle, the movement assistive device 10 can be optionally removed from the wheelchair 40 simply in a manual manner and uses the wheelchair 40 alone. Further, in addition to the wheelchair, the movement assistive device 10 can also be used with other types of apparatuses.

According to the present invention, different units and/or elements of the movement assistive device 10 can be assembled together by welding, riveting, screw-fastening or any other functionally similar connection means.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A movement assistive device, comprising:
a vertical lift module including a lift table that is vertically movable upward and downward; and
a horizontal extension module being arranged on the lift table to move upward and downward along with the lift table, and being horizontally drivable to switch between a first state and a second state.

2. The movement assistive device as claimed in claim 1, wherein the vertical lift module further includes:
a base being located below the lift table and including a plurality of legs, a first locating sleeve, and a second locating sleeve;
a reduction unit being provided on the base and including an upright rotational screw rod, which is externally threaded to provide an external thread section thereon;
a lift power unit being connected to the reduction unit;
a first fixing bar and a second fixing bar being vertically downwardly inserted into the first locating sleeve and the second locating sleeve, respectively, so as to locate at two lateral outer sides of the rotational screw rod and be parallel to the rotational screw rod; and
a lift support unit including a flange portion, a sleeve portion upward projected from a center of the flange portion, and a bore axially extended through the sleeve portion and the flange portion and internally threaded to provide an internal thread section; and the lift support unit being externally fitted around the rotational screw rod with the internal thread section in the bore meshing with the external thread section on the rotational screw rod, and therefore being movable upward and downward on along the rotational screw rod.

3. The movement assistive device as claimed in claim 2, wherein the lift table includes:
a central hole extending through the lift table in a thickness direction thereof and being externally fitted around the sleeve portion of the lift support unit, enabling the lift table to be supported on the flange portion of the lift support unit; and
a first and a second supporting arm separately located at two lateral sides of the lift table; the first supporting arm having a first locating hole provided thereon for movably fitting around the first fixing bar; and the second supporting arm having a second locating hole provided thereon for movably fitting around the second fixing bar.

4. The movement assistive device as claimed in claim 3, wherein the horizontal extension module includes:
a first slide unit and a second slide unit being arranged atop the lift table, and the first and the second slide unit being spaced from and parallel to each other; and
a horizontal displacement unit being located between and connected to the first and the second slide unit to move horizontally; wherein when the horizontal extension module is in the first state, the horizontal displacement unit brings the first and the second slide unit to move from a first position to a second position, and when the horizontal extension module is in the second state, the horizontal displacement unit brings the first and the second slide unit to move from the second position back to the first position.

5. The movement assistive device as claimed in claim 4, wherein:
the first slide unit includes a first case and a first slide; the first case being provided at an end with a first connection sleeve for movably fitting around the first fixing bar, and another end of the first case opposite to the first connection sleeve being an open end; and the first slide being received in and slidable relative to the first case to be extendable from and retractable into the first case via the open end thereof; and wherein:
the second slide unit includes a second case and a second slide; the second case being provided at an end with a second connection sleeve for movably fitting around the second fixing bar, and another end of the second case opposite to the second connection sleeve being an open end; and the second slide being received in and slidable relative to the second case to be extendable from and retractable into the second case via the open end thereof.

6. The movement assistive device as claimed in claim 5, wherein the horizontal displacement unit includes:
a first coupled section being connected to the first slide;
a second coupled section being connected to the second slide;
a first crossbar being connected at two opposite ends to the first case of the first slide unit and the second case of the second slide unit, respectively;
a second crossbar being connected at two opposite ends to the first coupled section and the second coupled section, respectively;
a scissor structure unit being movably connected to between the first crossbar and the second crossbar, and including a plurality of intersected first and second link bar sets that are pivotally connected end-to-end; the intersected first and second link bars in each set being pivotally connected to each other at a middle pivot point formed at middle points of the intersected first and second link bars; the scissor structure unit having a first outer side corresponding to the first crossbar and a second outer side corresponding to the second crossbar; the interested first and second link bars that form the first outer side and the intersected first and second link bars that form the second outer side of the scissor structure unit being movably connected at respective outer end to the first crossbar and the second crossbar, respectively, via a movable ring each; and
a horizontal power element being connected to the lift table of the vertical lift module and the first outer side of the scissor structure unit.

7. The movement assistive device as claimed in claim 6, wherein the lift power unit is an electric motor; and wherein the horizontal power element is selected from the group consisting of an air cylinder and a hydraulic cylinder, and includes a barrel connected to the lift table and a piston rod connected to the middle pivot point of the intersected first and second link bars that form the first outer side of the scissor structure unit.

8. The movement assistive device as claimed in claim 2, wherein the vertical lift module further includes a manual operation unit connected to the reduction unit.

9. A wheelchair, comprising:
a wheelchair main body; and
a movement assistive device being mounted to the wheelchair main body, and including:
a vertical lift module including a lift table that is vertically movable upward and downward; and
a horizontal extension module being arranged on the lift table to move upward and downward along with the lift table, and being horizontally drivable to switch from a first state to a second state and switch from the second state back to the first state.

10. The wheelchair as claimed in claim 9, wherein the vertical lift module further includes:
a base being located below the lift table and including a plurality of legs, a first locating sleeve, and a second locating sleeve;
a reduction unit being provided on the base and including an upright rotational screw rod, which is externally threaded to provide an external thread section thereon;
a lift power unit being connected to the reduction unit;
a first fixing bar and a second fixing bar being vertically downwardly inserted into the first locating sleeve and the second locating sleeve, respectively, so as to locate at two lateral outer sides of the rotational screw rod and be parallel to the rotational screw rod; and
a lift support unit including a flange portion, a sleeve portion upward projected from a center of the flange portion, and a bore axially extended through the sleeve portion and the flange portion and internally threaded to provide an internal thread section; and the lift support unit being externally fitted around the rotational screw rod with the internal thread section in the bore meshing with the external thread section on the rotational screw rod, and therefore being movable upward and downward on along the rotational screw rod.

11. The wheelchair as claimed in claim 10, wherein the lift table includes:
a central hole extending through the lift table in a thickness direction thereof and being externally fitted around the sleeve portion of the lift support unit, enabling the lift table to be supported on the flange portion of the lift support unit; and
a first and a second supporting arm separately located at two lateral sides of the lift table; the first supporting arm having a first locating hole provided thereon for movably fitting around the first fixing bar; and the second supporting arm having a second locating hole provided thereon for movably fitting around the second fixing bar.

12. The wheelchair as claimed in claim 11, wherein the horizontal extension module includes:
a first slide unit and a second slide unit being arranged atop the lift table, and the first and the second slide unit being spaced from and parallel to each other; and
a horizontal displacement unit being located between and connected to the first and the second slide unit to move horizontally; wherein when the horizontal extension module is in the first state, the horizontal displacement unit brings the first and the second slide unit to move from a first position to a second position, and when the horizontal extension module is in the second state, the horizontal displacement unit brings the first and the second slide unit to move from the second position back to the first position.

13. The wheelchair as claimed in claim 12, wherein:
the first slide unit includes a first case and a first slide; the first case being provided at an end with a first connection sleeve for movably fitting around the first fixing bar, and another end of the first case opposite to the first connection sleeve being an open end; and the first slide being received in and slidable relative to the first case to be extendable from and retractable into the first case via the open end thereof; and wherein:
the second slide unit includes a second case and a second slide; the second case being provided at an end with a second connection sleeve for movably fitting around the second fixing bar, and another end of the second case opposite to the second connection sleeve being an open end; and the second slide being received in and slidable relative to the second case to be extendable from and retractable into the second case via the open end thereof.

14. The wheelchair as claimed in claim 13, wherein the horizontal displacement unit includes:
a first coupled section being connected to the first slide and the wheelchair main body;
a second coupled section being connected to the second slide and the wheelchair main body;
a first crossbar being connected at two opposite ends to the first case of the first slide unit and the second case of the second slide unit, respectively;
a second crossbar being connected at two opposite ends to the first coupled section and the second coupled section, respectively;
a scissor structure unit being movably connected to between the first crossbar and the second crossbar, and including a plurality of intersected first and second link bar sets that are pivotally connected end-to-end; the intersected first and second link bars in each set being pivotally connected to each other at a middle pivot point formed at middle points of the intersected first and second link bars; the scissor structure unit having a first outer side corresponding to the first crossbar and a second outer side corresponding to the second crossbar; the interested first and second link bars that form the first outer side and the intersected first and second link bars that form the second outer side of the scissor structure unit being movably connected at respective outer end to the first crossbar and the second crossbar, respectively, via a movable ring each; and
a horizontal power element being connected to the lift table of the vertical lift module and the first outer side of the scissor structure unit.

15. The wheelchair as claimed in claim 14, wherein the lift power unit is an electric motor; and wherein the horizontal power element is selected from the group consisting of an air cylinder and a hydraulic cylinder, and includes a barrel connected to the lift table and a piston rod connected to the middle pivot point of the intersected first and second link bars that form the first outer side of the scissor structure unit.

16. The wheelchair as claimed in claim 10, wherein the wheelchair main body includes a first frame and a second frame that are laterally corresponding to but spaced from each other, and a seat and back upholstery connected to between the first and the second frame to locate above the movement assistive device.

17. The wheelchair as claimed in claim 16, further comprising a plurality of wheels;
and the wheels being rotatably mounted to positions selected from the group consisting of bottom sides of the legs of the base of the vertical lift module, and two lateral outer sides of the wheelchair main body.

18. The wheelchair as claimed in claim 10, wherein the vertical lift module further includes a manual operation unit connected to the reduction unit.
